(19) United States
(12) Patent Application Publication
(10) Pub. No.: US 2025/0103917 A1
(43) Pub. Date: Mar. 27, 2025

(54) KNOWLEDGE DISTILLATION BASED CONTINUAL SEMANTIC SEGMENTATION APPARATUS AND METHOD OF TRAINING CONTINUAL SEMANTIC SEGMENTATION MODEL THEREOF

(71) Applicants: Hyundai Motor Company, Seoul (KR); Kia Corporation, Seoul (KR); Nanyang Technological University, Singapore (SG)

(72) Inventors: Minhoe Hur, Singapore (SG); Evan Ling, Singapore (SG); Ze Yang, Singapore (SG); Dezhao Huang, Singapore (SG); Guosheng Lin, Singapore (SG)

(21) Appl. No.: 18/892,269

(22) Filed: Sep. 20, 2024

(30) Foreign Application Priority Data
Sep. 26, 2023 (KR) 10-2023-0129879
Aug. 21, 2024 (KR) 10-2024-0112291

(51) Int. Cl. G06N 5/022

(52) U.S. Cl. CPC G06N 5/022

(57) ABSTRACT

A method of training a knowledge distillation based continual semantic segmentation model may include training the continual semantic segmentation model based on training data, predicting a probability for each class of an output of a current continual semantic segmentation model that has been generated by being trained and a probability for each class of an output of an old continual semantic segmentation model, expanding a class related to the old continual semantic segmentation model so that a spatial dimension of a class related to the old continual semantic segmentation model is the same as a spatial dimension of a class related to the current continual semantic segmentation model, calculating knowledge distillation loss based on the predicted probability for each class, and updating the current continual semantic segmentation model based on the knowledge distillation loss.

### CROSS REFERENCE TO RELATED APPLICATION

The present application claims under 35 U.S.C. § 119(a) the benefit of Korean Patent Application No. 10-2023-0129879, filed on Sep. 26, 2023, and Korean Patent Application No. 10-2024-0112291, filed on Aug. 21, 2024, the entire contents of which are incorporated by reference herein.

### BACKGROUND

### (a) Technical Field

The present disclosure relates to continual semantic segmentation, more particularly, to a knowledge distillation based continual semantic segmentation apparatus and a method of training a continual semantic segmentation model thereof.

### (b) Description of the Related Art

Continual semantic segmentation (CSS) aims to expand an existing model to process a task while maintaining existing knowledge without accessing old training data.

Simply fine-tuning the existing model for new data may cause fatal errors. As a solution to this problem, there is knowledge distillation (KD), and according to the knowledge distillation (KD), the output distribution of a new model is normalized to be similar to the output distribution of an old model.

Conventional knowledge distillation (KD)-based continual semantic segmentation (CSS) methods tend to cause confusion between a background class and a novel class because they fail to establish reliable class correspondence for distillation. This hinders training of the novel class.

Therefore, there is a need for a method of effectively training the novel class by effectively distilling useful knowledge of the existing model into a new model without confusion.

The matters described as the background art are for the purpose of enhancing the understanding of the background of the present disclosure and should not be taken as acknowledging that they correspond to the related art already known to those skilled in the art.

### SUMMARY

Embodiments disclosed in the present disclosure are directed to providing a knowledge distillation based continual semantic segmentation apparatus and a method of training a continual semantic segmentation model thereof.

Embodiments are also directed to providing a knowledge distillation based continual semantic segmentation apparatus and a method of training a continual semantic segmentation model thereof, which are implemented to effectively distill useful knowledge of an existing model into a new model without confusion.

Embodiments are also directed to providing a knowledge distillation based continual semantic segmentation apparatus and a method of training a continual semantic segmentation model thereof, which classify, as a novel set, a novel class of an output of a current continual semantic segmentation model and a novel class of an output of an old continual semantic segmentation model and classify, as a background set, an old class and background of the output of the current continual semantic segmentation model and an old class and background of the output of the old continual semantic segmentation model.

The objects of the present disclosure are not limited to the above-described object, and other objects that are not mentioned will be able to be clearly understood by those skilled in the art to which the present disclosure pertains from the following description.

To achieve the objects, according to an embodiment of the present disclosure, there may be provided a knowledge distillation based continual semantic segmentation apparatus, which includes a memory including a continual semantic segmentation model, and a processor configured to train the continual semantic segmentation model.

According to an embodiment, the processor may be configured to train the continual semantic segmentation model based on training data, predict a probability for each class of an output of a current continual semantic segmentation model that has been generated by being trained and a probability for each class of an output of an old continual semantic segmentation model, expand a class related to the old continual semantic segmentation model so that a spatial dimension of the class related to the old continual semantic segmentation model is the same as a spatial dimension of the class related to the current continual semantic segmentation model, calculate knowledge distillation loss based on the predicted probability for each class, and update the current continual semantic segmentation model based on the knowledge distillation loss.

According to an embodiment, the processor may classify, as a novel set, a novel class of the output of the current continual semantic segmentation model and a novel class of the output of the old continual semantic segmentation model and classify, as a background set, an old class and background of the output of the current continual semantic segmentation model and an old class and background of the output of the old continual semantic segmentation model.

According to an embodiment, the processor may predict a probability of a novel class related to the current continual semantic segmentation model in the novel set, predict a probability of a novel class related to the old continual semantic segmentation model in the novel set, predict a probability of an old class and background related to the current continual semantic segmentation model in the background set, and predict a probability of an old class and background related to the old continual semantic segmentation model in the background set.

According to an embodiment, the processor may expand a class related to the old continual semantic segmentation model by assigning a novel class having zero probability to an output of the old continual semantic segmentation model in the novel set and expand a class related to the old continual semantic segmentation model by assigning the novel class having the zero probability to an output of the old continual semantic segmentation model in the background set.

According to an embodiment, the processor may calculate knowledge distillation loss for the novel set based on probabilities for classes related to the current and old continual semantic segmentation models in the novel set and calculate knowledge distillation loss for classes related to the current and old continual semantic segmentation models in the background set.

According to an embodiment, the class related to the old continual semantic segmentation model may include an expanded class.

According to an embodiment, the processor may determine whether training for the continual semantic segmentation model has been completed, in response that the training is completed, load a new continual semantic segmentation model, determine whether a new task is present after loading the new continual semantic segmentation model, and in response that the new task is present, further perform training for the new continual semantic segmentation model.

According to an embodiment, the processor may end the training in response that the new task is not present.

According to an embodiment of the present disclosure, there may be provided a method of training a continual semantic segmentation model by a continual semantic segmentation apparatus, which includes the following steps that may be carried out by a processor: training the continual semantic segmentation model based on training data, predicting a probability for each class of an output of a current continual semantic segmentation model that has been generated by being trained and a probability for each class of an output of an old continual semantic segmentation model, expanding a class related to the old continual semantic segmentation model so that a spatial dimension of a class related to the old continual semantic segmentation model is the same as a spatial dimension of a class related to the current continual semantic segmentation model, calculating knowledge distillation loss based on the predicted probability for each class, and updating the current continual semantic segmentation model based on the knowledge distillation loss.

According to an embodiment, the method may include, before the predicting, classifying, as a novel set, a novel class of the output of the current continual semantic segmentation model and a novel class of the output of the old continual semantic segmentation model and classifying, as a background set, an old class and background of the output of the current continual semantic segmentation model and an old class and background of the output of the old continual semantic segmentation model.

According to an embodiment, the predicting may include predicting a probability of a novel class related to the current continual semantic segmentation model in the novel set, predicting a probability of a novel class related to the old continual semantic segmentation model in the novel set, predicting a probability of an old class and background related to the current continual semantic segmentation model in the background set, and predicting a probability of an old class and background related to the old continual semantic segmentation model in the background set.

According to an embodiment, the expanding may include expanding a class related to the old continual semantic segmentation model by assigning a novel class having zero probability to the output of the old continual semantic segmentation model in the novel set and expanding a class related to the old continual semantic segmentation model by assigning the novel class having the zero probability to the output of the old continual semantic segmentation model in the background set.

According to an embodiment, the calculating may include calculating knowledge distillation loss for the novel set based on probabilities for classes related to the current and old continual semantic segmentation models in the novel set and calculating knowledge distillation loss for classes related to the current and old continual semantic segmentation models in the background set.

According to an embodiment, the class related to the old continual semantic segmentation model may include an expanded class.

According to an embodiment, the method may further include determining whether the training for the continual semantic segmentation model has been completed, loading a new continual semantic segmentation model in response that the training is completed, determining whether a new task is present after loading the new continual semantic segmentation model, and performing training for the new continual semantic segmentation model in response that the new task is present.

According to the present disclosure, there may be provided the knowledge distillation based continual semantic segmentation apparatus and the method of training the continual semantic segmentation model thereof.

In case that the continual semantic segmentation model is trained using the training method according to the embodiments, the useful knowledge of the exiting model can be effectively distilled into the new model without confusion.

Since the training method according to the embodiments can be applied to various actual applications, it is possible to expand the model to cope with other tasks without re-training the distributed model from the beginning, thereby saving significant time and computing resource.

The continual semantic segmentation model may be applied to a vehicle.

In case that the training method according to the embodiments is used, a continual semantic segmentation model applied to an autonomous part pickup system for a vehicle A can be easily changed to be applied to another autonomous part pickup system for another vehicle B.

The effects obtainable from the present disclosure are not limited to the above-described effects, and other effects that are not mentioned will be able to be clearly understood by those skilled in the art to which the disclosure pertains from the following description.

### BRIEF DESCRIPTION OF THE DRAWINGS

FIG. 1 is a view showing a knowledge distillation based continual semantic segmentation apparatus 100 according to an embodiment of the present disclosure.

FIG. 2 is a view for describing a method of training a continual semantic segmentation model according to the embodiment of the present disclosure.

FIG. 3 is a view exemplarily showing a process of classifying a class in a method of training the continual semantic segmentation model according to the embodiment of the present disclosure.

FIG. 4 is a view for describing probability prediction and knowledge distillation loss for a class in the method of training the continual semantic segmentation model according to the embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

In describing the embodiments disclosed in the specification, when it is determined that a detailed description of a related known technology may obscure the gist of the embodiments disclosed in this specification, a detailed description thereof will be omitted. In addition, the accompanying drawings are only for easy understanding of the embodiments disclosed in the specification, and it should be understood that the technical spirit disclosed in the specification is not limited by the accompanying drawings, and all changes, equivalents, or substitutes included in the spirit and technical scope of the present disclosure are included in the accompanying drawings.

Terms including ordinal numbers such as first or second may be used to describe various components, but the components are not limited by the terms. The terms are used only for the purpose of distinguishing one component from another.

The singular includes the plural unless the context clearly dictates otherwise.

In the specification, it should be understood that the term “comprise” or “have” is intended to specify that a feature, a number, a step, an operation, a component, a part, or a combination thereof described in the specification is present, but do not preclude the possibility of the presence or addition of one or more other features, numbers, steps, operations, components, parts, or combinations thereof.

When a first component is described as being “connected” or “coupled” to a second component, it should be understood that the first component may be directly connected or coupled to the second component or a third component may be present therebetween. On the other hand, when a certain component is described as being “directly connected” or “directly coupled” to another component, it should be understood that other components are not present therebetween.

Hereinafter, embodiments disclosed in this specification will be described in detail with reference to the accompanying drawings, and the same or similar components are denoted by the same reference numerals regardless of the drawing symbols, and overlapping descriptions thereof will be omitted.

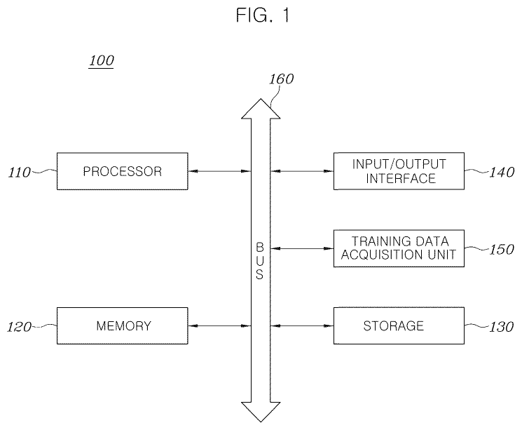

FIG. 1 is a view showing a knowledge distillation based continual semantic segmentation apparatus 100 according to an embodiment of the present disclosure.

The knowledge distillation based continual semantic segmentation apparatus 100 according to an embodiment may be a computing device implemented to perform continual semantic segmentation on input data.

The continual semantic segmentation apparatus 100 may perform continual semantic segmentation on data based on a continual semantic segmentation model having a neural network structure of artificial intelligence.

The continual semantic segmentation model of the continual semantic segmentation apparatus 100 may be updated through training.

According to an embodiment, the input data may be separated into two sets based on a ground truth label available at a current stage. According to an embodiment, the two sets may include a novel set and a background set.

That is, the input data may be separated into the novel set and the background set based on the ground truth label. Therefore, the approach according to the embodiment of the present disclosure may be referred to as “label-guided.”

As described above, since the input data is separated into the two sets (novel set, background set) according to the ground truth, it is possible to facilitate a customized knowledge distillation design.

The knowledge distillation according to the embodiment of the present disclosure maintains an output of a new model and modifies the existing model instead of modifying the output of the new model. Therefore, it is possible to prevent information loss due to probability combination or removal.

In addition, since the existing background knowledge is accurately extracted as a novel class corresponding to the ground truth through a probability transplantation operation, it is possible to effectively improve the generalization ability.

According to an embodiment, the continual semantic segmentation apparatus 100 may include a processor 110, a memory 120, a storage 130, an input/output interface 140, a training data acquisition unit 150, and a bus 160.

The processor 110 may be a data processing device implemented as hardware having a physical structure for executing desired operations.

The processor 110 may control the overall operation of each component of the continual semantic segmentation apparatus 100. For example, the processor 110 may include at least one of a central processing unit (CPU), a microprocessor unit (MPU), a micro controller unit (MCU), a graphics processing unit (GPU), or any other form of processor well known in the art of the present disclosure.

In addition, the processor 110 may perform calculations for at least one application or program for executing methods/operations according to various embodiments of the present disclosure.

The memory 120 may store various data, commands, and/or information. The memory 120 may load one or more computer programs from a storage 130 to execute the methods/operations according to various embodiments of the present disclosure.

For example, the memory 120 may be a random access memory (RAM) or a dynamic random access memory (DRAM), but is not limited thereto, and may include at least one of other forms of memories well known in the art of the present disclosure.

The storage 130 may non-temporarily store one or more computer programs. For example, the storage 130 may include a nonvolatile memory such as a flash memory, a hard disk, a removable disk, or any type of computer-readable recording medium well known in the art to which the present disclosure pertains.

For example, the computer program may include one or more instructions in which the methods/operations according to various embodiments of the present disclosure are implemented. When the computer program is loaded into the memory 120, the processor 110 may perform the methods/operations according to various embodiments of the present disclosure by executing the one or more instructions.

The input/output interface 140 may receive commands, data, information, etc. from the outside of the continual semantic segmentation apparatus 100. The input/output interface 140 may output the operation results of the continual semantic segmentation apparatus 100. For example, the input/output interface 140 may include a keyboard, a mouse, a monitor, a touch screen, etc.

The training data acquisition unit 150 may acquire data used for training the continual semantic segmentation model.

Training data acquired by the training data acquisition unit 150 may be used by the processor (110) to train the continual semantic segmentation model. The training data acquired by the training data acquisition unit 150 may be stored in the storage 130.

The bus 160 may provide a communication function between the components of the continuous semantic segmentation apparatus 100. The bus 160 may include various types of buses such as an address bus, a data bus, and a control bus.

According to the embodiment of the present disclosure, the continual semantic segmentation apparatus 100 may classify, as one set (novel set), classes corresponding to the novel class among the classes output by each of the current and old continual semantic segmentation models and classify, as the other set (background set), classes corresponding to the old class and classes corresponding to the background.

The continual semantic segmentation apparatus 100 classifies the classes output by each of the current and old continual semantic segmentation models as different sets, which can be referred to as “class separation.”

According to an embodiment, the continual semantic segmentation apparatus 100 may predict the probability for classes corresponding to the output of the current continual semantic segmentation model among the classes included in the novel set and predict the probability for classes corresponding to the output of the old continual semantic segmentation model among the classes included in the novel set.

The continual semantic segmentation apparatus 100 may expand the output of the old continual semantic segmentation model by assigning a novel class having zero probability to the output of the old continual semantic segmentation model so that, with respect to the novel set, an output class spatial dimension of the old continual semantic segmentation model is the same as an output class spatial dimension of the current continual semantic segmentation model.

For example, when, with respect to the novel set, the output classes of the current continual semantic segmentation model are 5 and the output classes of the old continual semantic segmentation model are 3, the continual semantic segmentation apparatus 100 may expand the output classes of the old continual semantic segmentation model to 5 by assigning two novel classes with zero probability to the output of the old continual semantic segmentation model so that dimensions of the output classes of the old continual semantic segmentation model are the same as dimensions of the output classes of the current continual semantic segmentation model.

The continual semantic segmentation apparatus 100 may expand the output of the old continual semantic segmentation model and then transplant a background probability to the expanded class, and other probabilities can be maintained.

The continual semantic segmentation apparatus 100 may expand the output of the old continual semantic segmentation model based on Equation 1 below.

$${\overline{q}}_{x}^{t - 1} ( i , c ) = \{ \begin{matrix}0 & if c ∈ {𝒞}^{t} and c \neq {y}_{i} \\ {q}_{x}^{t - 1} ( i , b ) & if c = {y}_{i} \\ {q}_{x}^{t - 1} ( i , c ) & otherwise\end{matrix} , \qquad [ Equation 1 ]$$

Here, [symbol] (i, c) denotes a probability of class c for pixel i in the expanded class of the output of the old continual semantic segmentation model, [symbol] ₓ^{t-1}(i, b) denotes a probability of class b for pixel i in the output of the old continual semantic segmentation model, and [symbol] ₓ^{t-1}(i, c) denotes a probability of class c for pixel i in the output of the old continual semantic segmentation model.

According to an embodiment, the continual semantic segmentation apparatus 100 may predict the probability for the class of the output of the current continual semantic segmentation model among the classes included in the background set and predict the probability for the class of the output of the old continual semantic segmentation model among the classes included in the background set.

The continual semantic segmentation apparatus 100 may expand the output of the old continual semantic segmentation model by assigning a novel class having zero probability to the output of the old continual semantic segmentation model so that, with respect to the background set, an output class spatial dimension of the old continual semantic segmentation model is the same as an output class spatial dimension of the current continual semantic segmentation model.

For example, when, with respect to the background set, the output classes of the current continual semantic segmentation model are 5 and the output classes of the old continual semantic segmentation model are 3, the continual semantic segmentation apparatus 100 may expand the output classes of the old continual semantic segmentation model to 5 by assigning two novel classes with zero probability to the output of the old continual semantic segmentation model so that dimensions of the output classes of the old continual semantic segmentation model are the same as dimensions of the output classes of the current continual semantic segmentation model.

The continual semantic segmentation apparatus 100 may expand the output of the old continual semantic segmentation model based on Equation 2 below.

$${\overline{q}}_{x}^{t - 1} ( i , c ) = \{ \begin{matrix}0 & if c ∈ {𝒞}^{t} \backslash b \\ {q}_{x}^{t - 1} ( i , c ) & otherwise\end{matrix} . \qquad [ Equation 2 ]$$

Here, [symbol] (i, c) denotes a probability of class c for pixel i in the expanded class of the output of the old continual semantic segmentation model and [symbol] (i, c) denotes a probability of class c for pixel i in the output of the old continual semantic segmentation model.

According to an embodiment, the continual semantic segmentation apparatus 100 may calculate knowledge distillation loss [symbol] _{kd}^{θ}^{ₜ}(x, y) for the current set.

According to an embodiment, the continual semantic segmentation apparatus 100 may calculate knowledge distillation loss [symbol] _{kd}^{θ}^{ₜ}(x, y) for the current set based on Equation 3 below.

$${ℓ}_{kd}^{{θ}^{t}} ( x , y ) = {λ}_{n} \cdot {\overline{ℓ}}_{kd}^{{θ}^{t}} ( x , y , {S}_{n} ) + {λ}_{b} \cdot {\overline{ℓ}}_{kd}^{{θ}^{t}} ( x , y , {𝒮}_{b} ) \qquad [ Equation 3 ]$$

Here, [symbol] _{kd}^{θ}^{ₜ}(x, y, Sₙ) denotes the knowledge distillation loss for the novel set, [symbol] _{kd}^{θ}^{ₜ}(x, y, S_{b}) denotes the distillation loss for the background set, and λₙ and λ_{b} denote weights for adjusting the contribution to the knowledge distillation loss of the novel set and the knowledge distillation loss of the background set.

According to an embodiment, the knowledge distillation loss [symbol] _{kd}^{θ}^{ₜ}(x, y, S) for the current set S can be defined as Equation 4 below.

$${\overline{ℓ}}_{kd}^{{θ}^{t}} ( x , y , 𝒮 ) = - \frac{1}{N} {\sum }_{i ∈ 𝒮} {\sum }_{c ∈ {𝒞}^{0 : t}} {\overline{q}}_{x}^{t - 1} ( i , c ) log {q}_{x}^{t} ( i , c ) \qquad [ Equation 4 ]$$

Here, [symbol] (i, c) denotes a probability of class c for pixel i in the output of the old continual semantic segmentation model and [symbol] ₓ^{t}(i, c) denotes a probability of class c for pixel i in the output of the current continual semantic segmentation model.

According to an embodiment, the continual semantic segmentation apparatus 100 may calculate the knowledge distillation loss for each of the novel set and the background set as defined in Equation 1.

The continual semantic segmentation apparatus 100 may calculate the knowledge distillation loss for the novel set based on the probability for the classes corresponding to the output of the current continual semantic segmentation model and the probability for the classes after expanding the output of the old continual semantic segmentation model.

The continual semantic segmentation apparatus 100 may calculate the knowledge distillation loss for the background set based on the probability for the classes corresponding to the output of the current continual semantic segmentation model and the probability for the classes after expanding the output of the old continual semantic segmentation model.

According to an embodiment, the continual semantic segmentation apparatus 100 may update the current continual semantic segmentation model based on the calculated knowledge distillation loss.

The continual semantic segmentation apparatus 100 may update the current continual semantic segmentation model based on the knowledge distillation loss for the output of the old continual semantic segmentation model and the knowledge distillation loss for the output of the current continual semantic segmentation model until training is completed.

The continual semantic segmentation apparatus 100 may assign the current continual semantic segmentation model to the old continual semantic segmentation model in response that a new task is present, assign the continual semantic segmentation model generated based on the new task to the current continual semantic segmentation model, and then update the current continual semantic segmentation model based on the knowledge distillation loss for the output of the old continual semantic segmentation model and the knowledge distillation loss for the output of the current continual semantic segmentation model until training is completed.

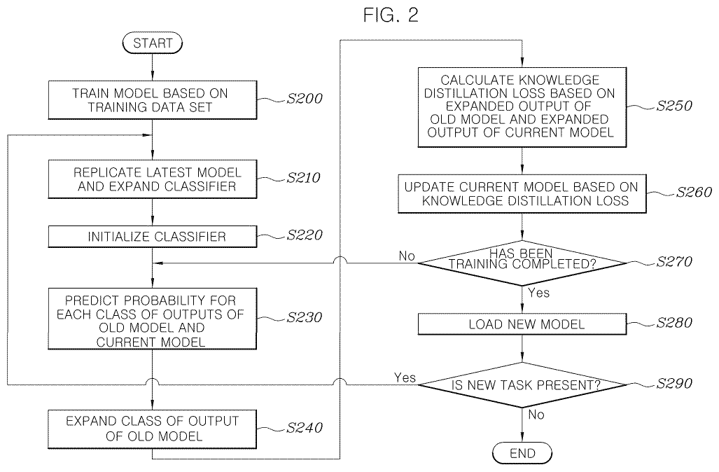

FIG. 2 is a view for describing a method of training a continual semantic segmentation model according to the embodiment of the present disclosure.

Each operation shown in FIG. 2 may be performed by the continual semantic segmentation apparatus 100 described with reference to FIG. 1 and performed as the processor 110 executes the continual semantic segmentation model in the memory 120.

Referring to FIG. 2, the processor 110 may train the continual semantic segmentation model based on a training data set (S200).

The processor 110 may predict the probability for each class of the output of the current continual semantic segmentation model that has been generated by being trained and the probability for each class of the output of the old continual semantic segmentation model (S230).

According to an embodiment, before performing operation S230, the processor 110 may replicate the current continual semantic segmentation model and expand a classifier (S210) and initialize the classifier (S220).

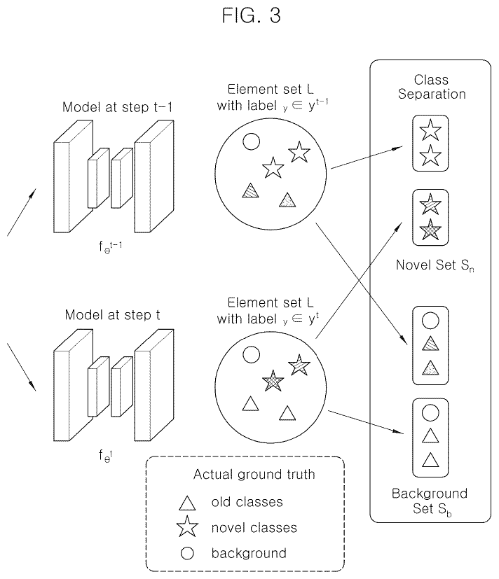

FIG. 3 is a view exemplarily showing a process of classifying a class in a method of training the continual semantic segmentation model according to the embodiment of the present disclosure.

As shown in FIG. 3, before performing operation S230, the processor 110 may classify, as a novel set Sₙ, a novel class of the output of the current continual semantic segmentation model (model at step t) and a novel class of the output of the old continual semantic segmentation model (model at step t−1) and classify, as a background set S_{b}, the old class and background of the output of the current continual semantic segmentation model and the old class and background of the output of the old continual semantic segmentation model.

In operation S230, the processor 110 may predict the probability for a novel class related to the current continual semantic segmentation model in the novel set and predict the probability for a novel class related to the old continual semantic segmentation model in the novel set.

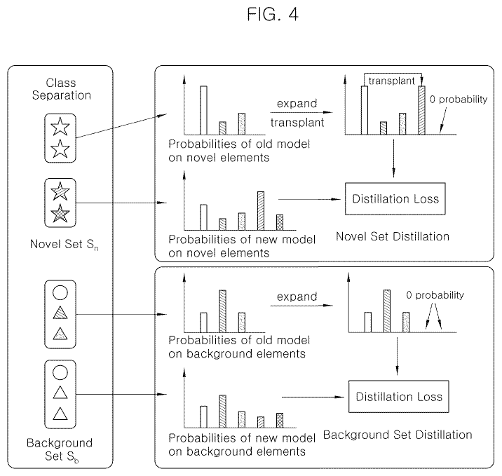

FIG. 4 is a view for describing probability prediction and knowledge distillation loss for a class in the method of training the continual semantic segmentation model according to the embodiment of the present disclosure.

Referring to FIG. 4 together, the processor 110 may predict the probability for an old class and background related to the current continual semantic segmentation model in the background set and predict the probability for an old class and background related to the old continual semantic segmentation model in the background set.

After operation S230, the processor 110 may expand the class related to the old continual semantic segmentation model so that the spatial dimension of the class related to the old continual semantic segmentation model is the same as the spatial dimension of the class related to the current continual semantic segmentation model (S240).

In operation S240, the processor 110 may expand the class related to the old continual semantic segmentation model by assigning the novel class having zero probability to the output of the old continual semantic segmentation model in the novel set.

In addition, the processor 110 may expand the class related to the old continual semantic segmentation model by assigning the novel class having zero probability to the output of the old continual semantic segmentation model in the background set.

After operation S240, the processor 110 may calculate the knowledge distillation loss for each of the novel set and the background set (S250).

In operation S250, the processor 110 may calculate the knowledge distillation loss for the novel set based on the probabilities for the classes related to the current and old continual semantic segmentation models in the novel set.

In this case, the class related to the old continual semantic segmentation model may include the expanded class.

In addition, the processor 110 may calculate the knowledge distillation loss for the background set based on the probabilities for the classes related to the current and old continual semantic segmentation models in the background set.

In this case, the class related to the old continual semantic segmentation model may include the extended class.

After operation S250, the processor 110 may update the current continual semantic segmentation model based on the calculated knowledge distillation loss (S260).

After operation S260, the processor 110 may determine whether the training has been completed (S270), and in response that the training is completed (Yes in S270), load a new continual semantic segmentation model for training (S280), and determine whether a new task is present (S290).

In response that the new task is present (Yes in S290), the processor 110 may return to operation S210 and perform operation S210, and in response that the new task is not present (No in S290), end the training of the continual semantic segmentation model.

In response that the training is not completed (No in S270), the processor 110 may return to operation S230 and perform operation S230.

Although the embodiments of the present disclosure have been described in more detail with reference to the accompanying drawings, the present disclosure is not necessarily limited to these embodiments, and various modifications may be carried out without departing from the technical spirit of the present disclosure. Therefore, the embodiments disclosed herein are not intended to limit the technical spirit of the present disclosure, but for illustrative purposes, and the scope of the technical spirit of the present disclosure is not limited by these embodiments. Therefore, it should be understood that the above-described embodiments are illustrative and not restrictive in all aspects. The scope of the present disclosure should be construed by the claims, and all technical spirits within the equivalent range should be construed as being included in the scope of the present disclosure.

What is claimed is:

1. A knowledge distillation based continual semantic segmentation apparatus, the apparatus comprising:
a memory including a continual semantic segmentation model; and
a processor configured to train the continual semantic segmentation model,
wherein the processor is configured to:
train the continual semantic segmentation model based on training data;
predict a probability for each class of an output of a current continual semantic segmentation model that has been generated by being trained and a probability for each class of an output of an old continual semantic segmentation model;
expand a class related to the old continual semantic segmentation model so that a spatial dimension of the class related to the old continual semantic segmentation model is the same as a spatial dimension of the class related to the current continual semantic segmentation model;
calculate knowledge distillation loss based on the predicted probability for each class; and
update the current continual semantic segmentation model based on the knowledge distillation loss.

2. The apparatus of claim 1, wherein the processor is configured to classify, as a novel set, a novel class of the output of the current continual semantic segmentation model and a novel class of the output of the old continual semantic segmentation model and classify, as a background set, an old class and background of the output of the current continual semantic segmentation model and an old class and background of the output of the old continual semantic segmentation model.

3. The apparatus of claim 2, wherein the processor is configured to predict a probability of a novel class related to the current continual semantic segmentation model in the novel set, predict a probability of a novel class related to the old continual semantic segmentation model in the novel set, predict a probability of an old class and background related to the current continual semantic segmentation model in the background set, and predict a probability of an old class and background related to the old continual semantic segmentation model in the background set.

4. The apparatus of claim 2, wherein the processor is configured to expand a class related to the old continual semantic segmentation model by assigning a novel class having zero probability to an output of the old continual semantic segmentation model in the novel set and expand a class related to the old continual semantic segmentation model by assigning the novel class having the zero probability to an output of the old continual semantic segmentation model in the background set.

5. The apparatus of claim 2, wherein the processor is configured to calculate knowledge distillation loss for the novel set based on probabilities for classes related to the current and old continual semantic segmentation models in the novel set and calculate knowledge distillation loss for classes related to the current and old continual semantic segmentation models in the background set.

6. The apparatus of claim 5, wherein the class related to the old continual semantic segmentation model includes an expanded class.

7. The apparatus of claim 1, wherein the processor is configured to determine whether training for the continual semantic segmentation model has been completed, in response that the training is completed, load a new continual semantic segmentation model, determine whether a new task is present after loading the new continual semantic segmentation model, and in response that the new task is present, further perform training for the new continual semantic segmentation model.

8. The apparatus of claim 7, wherein the processor is configured to end the training in response that the new task is not present.

9. The apparatus of claim 1, wherein the continual semantic segmentation model is applied to a vehicle.

10. The apparatus of claim 1, wherein the continual semantic segmentation model is applied to an autonomous part pickup system for a vehicle.

11. The apparatus of claim 10, wherein the continual semantic segmentation model is changed to another autonomous part pickup system for another vehicle.

12. A method of training a continual semantic segmentation model by a continual semantic segmentation apparatus, the method comprising:
training, by a processor, the continual semantic segmentation model based on training data;
predicting, by the processor, a probability for each class of an output of a current continual semantic segmentation model that has been generated by being trained and a probability for each class of an output of an old continual semantic segmentation model;
expanding, by the processor, a class related to the old continual semantic segmentation model so that a spatial dimension of a class related to the old continual semantic segmentation model is the same as a spatial dimension of a class related to the current continual semantic segmentation model;
calculating, by the processor, knowledge distillation loss based on the predicted probability for each class; and
updating, by the processor, the current continual semantic segmentation model based on the knowledge distillation loss.

13. The method of claim 12, before the predicting, comprising:
classifying, as a novel set, a novel class of the output of the current continual semantic segmentation model and a novel class of the output of the old continual semantic segmentation model; and
classifying, as a background set, an old class and background of the output of the current continual semantic segmentation model and an old class and background of the output of the old continual semantic segmentation model.

14. The method of claim 13, wherein the predicting includes:
predicting a probability of a novel class related to the current continual semantic segmentation model in the novel set;
predicting a probability of a novel class related to the old continual semantic segmentation model in the novel set;
predicting a probability of an old class and background related to the current continual semantic segmentation model in the background set; and
predicting a probability of an old class and background related to the old continual semantic segmentation model in the background set.

15. The method of claim 13, wherein the expanding includes:
expanding a class related to the old continual semantic segmentation model by assigning a novel class having zero probability to the output of the old continual semantic segmentation model in the novel set; and
expanding a class related to the old continual semantic segmentation model by assigning the novel class having the zero probability to the output of the old continual semantic segmentation model in the background set.

16. The method of claim 13, wherein the calculating includes:
calculating knowledge distillation loss for the novel set based on probabilities for classes related to the current and old continual semantic segmentation models in the novel set; and
calculating knowledge distillation loss for classes related to the current and old continual semantic segmentation models in the background set.

17. The method of claim 16, wherein the class related to the old continual semantic segmentation model includes an expanded class.

18. The method of claim 12, further comprising:
determining whether the training for the continual semantic segmentation model has been completed;
loading a new continual semantic segmentation model in response that the training is completed;
determining whether a new task is present after loading the new continual semantic segmentation model; and
performing training for the new continual semantic segmentation model in response that the new task is present.

19. The method of claim 12, wherein the continual semantic segmentation model is applied to an autonomous part pickup system for a vehicle.

20. The method of claim 19, wherein the continual semantic segmentation model is changed to another autonomous part pickup system for another vehicle.
